(19) United States
(12) Patent Application Publication
(10) Pub. No.: US 2026/0349115 A1
(43) Pub. Date: Nov. 5, 2026

(54) SENSOR-BASED NAVIGATION SYSTEMS AND METHODS

(71) Applicant: Perennial Autonomy, LLC, Menlo Park, CA (US)

(72) Inventors: Kunal Kishore BAJAJ, San Francisco, CA (US); Jack MASON, San Francisco, CA (US); Joseph JAOUDI, Sunnyvale, CA (US)

(21) Appl. No.: 19/667,601

(22) Filed: May 4, 2026

Related U.S. Application Data
(60) Provisional application No. 63/800,413, filed on May 5, 2025.

(51) Int. Cl. G01S 17/931; G01S 7/481; G01S 13/42; G01S 17/42; G01S 17/86

(52) U.S. Cl. CPC G01S 17/931; G01S 7/4816; G01S 13/42; G01S 17/42; G01S 17/86

(57) ABSTRACT

Guidance and navigation systems and methods for a vehicle are disclosed that provide positioning and targeting in environments where global positioning system (GPS) signals are unreliable or unavailable. The system integrates a laser transmitter and a laser-detecting photodiode to transmit encoded laser signals and receive reflected laser returns from an object. Laser data, including signal strength, directional data, timing data, and encoded signatures are extracted to authenticate the reflected signal and compute a range and vector to the object, which is used to selectively adjust a trajectory of the vehicle, avoid the object, or execute a payload delivery.

### CROSS-REFERENCE TO RELATED APPLICATION

This application claims the benefit of U.S. Provisional Application No. 63/800,413 filed May 5, 2025, the entirety of which is hereby incorporated by reference herein.

### BACKGROUND

Conventional navigation and guidance systems typically depend on global positioning system (GPS) signals as their primary source of positioning data. While GPS-based approaches can provide acceptable accuracy under ideal conditions, they exhibit well-known limitations in environments where signal reception is degraded, obstructed, or intentionally disrupted. For example, in urban canyons formed by tall buildings, dense forested regions, subterranean or indoor settings, and contested electromagnetic environments (e.g., electronic warfare scenarios), GPS signals may suffer from multipath interference, attenuation, jamming, or spoofing. As a result, systems that rely predominantly on GPS may experience significant positioning errors, intermittent availability, or complete loss of navigational capability.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

Systems and methods for sensor-based navigation are provided. A first laser beam is transmitted, from a laser transmitter on a vehicle traveling on a defined trajectory toward an object, toward a direction of the object. The first laser beam includes a first laser signal having a first wavelength and a first signature encoded therein. A second laser beam having the first wavelength is received at a laser-detecting photodiode configured to detect laser beams within a defined wavelength range, the first wavelength being within the defined wavelength range. Laser data is determined from a second laser signal in the second laser beam. The laser data includes a signal strength, directional data, timing data, and an encoded signature. Based on the laser data, the second laser beam is identified as the first laser beam reflected off of the object. Based on identifying the second laser beam as the first laser beam reflected off the object, a range of the object and a vector to the object is computed using the signal strength, the directional data, and the timing data. Based on the range to the object and the vector to the object, one of the following is performed: adjusting a current trajectory of the vehicle such that the adjusted current trajectory is aligned with the object; adjusting the current trajectory of the vehicle such that the adjusted current trajectory is not aligned with the object; or executing a delivery of a payload on the vehicle.

### BRIEF DESCRIPTION OF THE DRAWINGS

The present description will be better understood from the following detailed description read considering the accompanying drawings, wherein:

FIG. 1 is a block diagram illustrating an example detection and guidance system;

FIGS. 2 and 3 are flowcharts illustrating example methods for guiding a vehicle relative to an object using encoded laser signals; and

FIG. 4 is a block diagram of an example computing apparatus for implementing examples of the present disclosure.

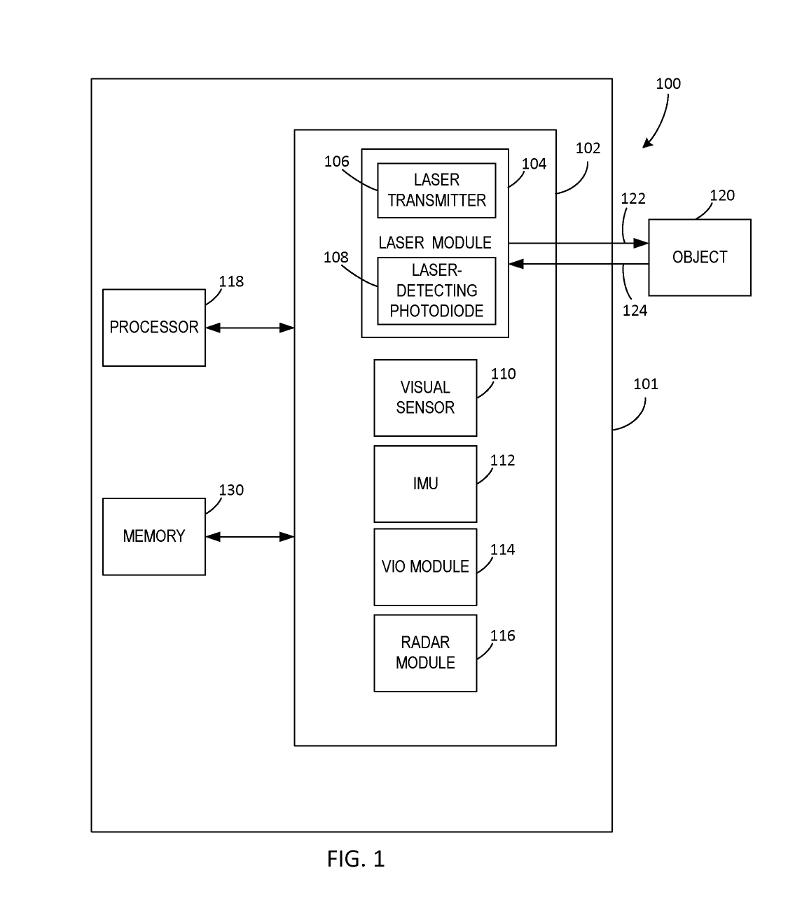

Corresponding reference characters indicate corresponding parts throughout the drawings. In FIGS. 1 to 4, the systems are illustrated as schematic drawings. The drawings may not be to scale. Any of the figures may be combined into a single example or embodiment.

### DETAILED DESCRIPTION

Some conventional systems incorporate inertial navigation systems (INS) or other supplementary sensors. However, inertial systems, while independent of external signals, are prone to drift over time due to the accumulation of measurement errors. Without reliable external corrections, often still derived from global positioning system (GPS) signals, these errors can grow unbounded, leading to degraded accuracy. Similarly, standalone optical or radar-based systems may be sensitive to environmental conditions such as lighting variability, weather effects, or terrain ambiguity, and are often not tightly integrated in a manner that fully compensates for the weaknesses of other subsystems.

Additionally, conventional architectures frequently treat sensor inputs in isolation. This can result in reduced resilience, particularly where one or more sensors are compromised. Moreover, targeting and ranging capabilities in conventional systems are often loosely coupled with navigation functions, leading to inefficiencies and reduced overall accuracy in applications requiring precise localization and object identification.

In contrast, aspects of the disclosure include an improved guidance and navigation system that enhance vehicle positioning and targeting accuracy in environments where GPS signals are unreliable or unavailable. Unlike conventional systems that heavily rely on GPS, the system described herein integrates various sensor technologies, including optical, inertial, and/or radar elements, to enable robust and adaptable navigation.

For example, aspects of the present disclosure include laser-based ranging and targeting systems working in tandem with navigation technologies to increase accuracy and overall capability. Laser return data is processed to assist with precise distance estimation and object identification. Navigation is also improved through techniques such as optical flow and visual-inertial odometry (VIO). VIO combines terrain imagery with inertial measurement unit (IMU) data to form a fused system that compensates for drift and cumulative error. Optional sensor inputs, including a radar module and a viewing sensor, offer redundancy and resilience in conditions where environmental interference may degrade other performance of other sensors. By integrating these components, the system delivers robust navigation and targeting performance.

Aspects of the disclosure are operable in a wide range of applications, such as commercial mobile platforms, search and rescue operations, automated ground vehicles, and exploration and scientific missions.

In a commercial scenario, the system can be utilized by mobile platforms for delivery services, agricultural monitoring, or surveying in areas with dense tree cover, urban obstacles, or when operating within buildings. The optical flow analysis and sensor fusion provide reliable navigation and positioning without reliance on external GPS infrastructure, ensuring continuity of service.

For search and rescue operations, the system's precise navigation and targeting capabilities are advantageous, particularly in remote or rugged terrains where GPS signals may be unavailable. The system allows rescue vehicles to precisely locate designated objects, such as stranded individuals or specific coordinates, using the laser designation and detection functionalities coupled with inertial and optical guidance.

In the context of automated ground vehicles, such as autonomous cars or robots, the system aids in path planning and obstacle avoidance in urban environments with poor GPS coverage due to skyscrapers, tunnels, or other obstructions. The integrated sensor fusion and mapping ensure consistent vehicle operation and navigation in mixed signal conditions.

For scientific exploration vehicles, such as those used in arctic or deep-sea expeditions, the system offers reliable guidance and positioning under harsh environmental conditions where other guidance systems may fail. The radar and visual systems are particularly valuable in environments where optical clarity is limited.

Aspects of the disclosure are operable in a variety of vehicles and operational scenarios, offering enhanced performance in environments where GPS signals are unreliable or compromised. An example implementation includes a laser transmitter and a laser-detecting photodiode on a vehicle. A laser beam transmitted by the laser transmitter is reflected off of an object and received by the laser-detecting photodiode, and based on an angle the reflected laser beam is received by the laser-detecting photodiode and a strength of a laser signal within the reflected laser beam, a range of the object and a vector to the object are computed and used to adjust a current trajectory of the vehicle to better align with the object. In some examples, the laser-detecting photodiodes include one or more of the following for detecting and decoding laser designation signals: forward diodes, positive-negative (PN) junction diodes, a quadrant photodetector, a quadrant laser spot tracker, and an avalanche photodiode. The system described herein authenticates a received laser beam by decoding laser data therein to obtain a laser signature to determine if the laser beam originated from the vehicle (e.g., the signature is recognized as originating from the vehicle), an adversarial source (e.g., the signature is not recognized), or a friendly source (e.g., the signal is recognized but did not originate from the vehicle).

The system is operable with any form of vehicle. Examples of vehicles include mobile platforms such as, but not limited to, uncrewed vehicles, land vehicles, uncrewed ground vehicles (UGVs), marine vehicles, surface vehicles, submersibles, uncrewed marine vehicles (UMVs), uncrewed surface and/or submersible vehicles (USVs), aircraft (e.g., fixed wing aircraft, rotorcraft, gliders, lighter-than-air craft, balloons, high-altitude balloons, uncrewed aerial vehicles (UAVs), etc.), rockets, missiles, space-based platforms, a platform carried by an individual (e.g., a backpack and/or other carrying pack, etc.), and/or the like. In some examples, a launching container assembly 100 as next described is used with uncrewed, autonomous mobile platforms.

In an implementation, the system includes a visual sensor, such as a downward-facing camera (such as a red, green, and blue (RGB) camera) that captures images of a terrain as the vehicle progresses along a trajectory. A processor uses the visual sensor data to perform optical flow analysis to evaluate movement with respect to a surface of the ground. This evaluated movement can be used to adjust a trajectory of the vehicle. For example, if the visual flow analysis indicates that the vehicle is off course from a defined trajectory, the trajectory of the vehicle can be adjusted to get back on course with the defined trajectory. In some examples, the data acquired from the visual flow analysis provides reference points that facilitate a recalibration of IMU readings, thereby improving an accuracy of roll and heading measurements.

In another implementation, the system integrates VIO to refine dead reckoning accuracy. In this implementation, a combination of visual data from the visual sensor with the IMU sensor readings are used. By resetting metrics when specific visual cues are detected, the system reduces cumulative errors in heading and roll estimation.

In another implementation, the system employs mapping and satellite alignment to enhance navigation. In this implementation, terrain imagery captured by the visual sensor is compared with pre-existing map data (e.g., from satellite imagery). By strategically correlating these data sources, the system derives headings and modifications to the vehicle's trajectory, ensuring accurate alignment with predetermined paths or objects.

In another implementation, the system described herein integrates a radar module, such as a Frequency Modulated Continuous Wave (FMCW) radar module. The radar module provides supplementary data related to range and vector, which is particularly valuable in situations where optical systems might be impacted by weather conditions or environmental scattering.

In another implementation, the system dynamically assigns weights to outputs from various sensors, such as the visual sensor, the IMU, the laser beam, and the radar module, based on operational conditions and environmental factors, to enable aggregation of these outputs thus enhancing the overall system accuracy and reliability. The ability to assign weights to each of the different sensor outputs and then combine them together allows for informed decision-making about navigation paths, evasive maneuvers, and engagement with objects, as well as refined vehicle trajectory adjustments and optimized navigation accuracy. Through this adaptive process, the system ensures that the most reliable data guides navigation/guidance decisions, maintaining robust performance.

An example technical effect of the system, apparatus, and method described herein is providing enhanced positioning and targeting accuracy in environments with unreliable GPS signals, by utilizing laser ranging and targeting in conjunction with navigation systems to enhance precision and functionality. Laser-based feedback guidance methods are employed to augment navigation by providing accurate distance readings and object designation capabilities. Navigation is further refined through optical flow analysis and visual-inertial odometry, which leverage terrain imagery and integrate with the IMU to provide a hybrid system that mitigates cumulative errors. Output from the radar module and the visual sensor serve as optional inputs to the system, offering additional means of detecting and tracking objects when environmental factors impact the performance of other systems and sensors. This integrated approach improves navigation and targeting accuracy.

Referring now to the figures, FIG. 1 is a block diagram illustrating a detection and guidance system 100. In some examples, the system 100 is implemented on a mobile platform (e.g., a vehicle 101).

The system 100 includes sensing components 102 coupled to the vehicle 101. The sensing components 102 include a laser module 104, a visual sensor 110, an IMU 112, a VIO module 114, and a radar module 116. The system 100 further includes a processor 118 and a memory 130. In some examples, the processor 118 executes instructions from each of the sensing components 102. In another example, each of the sensing components include their own processors (not shown). In another example, the processor 118 or an additional processor is located in a remote location, separate from the vehicle 101.

In some examples, the laser module 104 includes a laser transmitter 106 and a laser-detecting photodiode 108. In some examples, the laser-detecting photodiode 108 includes one or more of the following: a forward diode, a PN junction diode, a quadrant photodetector, a quadrant laser spot tracker, and an avalanche photodiode. In one example, as the vehicle 101 is on a defined trajectory toward an object 120, the laser transmitter 106 transmits a laser beam (e.g., laser beam 122) comprising a laser signal toward the object 120. In some examples, the laser beam 122 is a continuous-wave (CW) laser. In some examples, the laser beam 122 is a pulsed laser. When the laser beam 122 is reflected off of the object 120, the reflected laser beam (e.g., reflected laser beam 124) is received by the laser-detecting photodiode 108 and, based on an angle the reflected laser beam 124 is received by the laser-detecting photodiode 108 and a strength of a laser signal within the reflected laser beam 124, a range of the object 120 and a vector to the object 120 can be computed. This information is then used to adjust a current trajectory of the vehicle 101 to better align with the defined trajectory toward the object 120.

In some examples, prior to processing a laser beam (e.g., the reflected laser beam 124) received by the laser-detecting photodiode 108, it is determined whether the received laser beam is in fact a reflection of the laser beam 122 transmitted by the laser transmitter 106, or whether the received laser beam is from a source other than the laser transmitter 106, such as a friendly source or a hostile source. In one example, the laser beam 122 transmitted from the laser transmitter 106 has a particular wavelength and the laser-detecting photodiode 108 is configured to receive laser beams within a defined wavelength range, which includes the particular wavelength of the laser beam 122 transmitted from the laser transmitter 106. Thus, any laser beam that has a wavelength outside of the defined wavelength range of the laser-detecting photodiode will not be received or detected by the laser-detecting photodiode 108, or will be ignored by the laser-detecting photodiode 108 if received.

In some examples, prior to transmitting the laser beam 122 from the laser transmitter 106, the laser beam 122 is encoded with a signature that identifies the laser beam 122 as a laser beam transmitted from the laser transmitter 106 or from the system 100. Thus, once a laser beam is received by the laser-detecting diode 106, the processor 118 and/or the laser-detecting photodiode 108 decodes the laser signal within the laser beam to identify a laser signature. This authentication process utilizes predefined encoding patterns embedded within the laser signal. If the decoded laser signature matches the encoded laser signature of the laser beam 122 transmitted by the laser transmitter 106, the received laser beam (e.g., the reflected laser beam 124) is identified as the laser beam transmitted 122 from the laser transmitter 106 and reflected off the object 120. However, if the laser signal does not include a signature or if the decoded signature does not match the encoded signature from the laser beam 122 transmitted by the laser transmitter 106, the received laser beam is determined to be an unrecognized laser beam: not the laser beam 122 transmitted from the laser transmitter 106 and reflected off of the object 120. In this example, the unrecognized laser beam may be from a friendly source or a hostile source. In some examples, the decoded signature of the unrecognized laser beam is used to identify a source of the unrecognized laser beam. In other examples, a strength of the unrecognized laser beam is all that is needed to determine that the unrecognized laser beam is not the laser beam 122 transmitted from the laser transmitter 106 and reflected off of the object 120 since the unrecognized laser beam may be transmitted directly from a source without reflection. In this example, the unrecognized laser beam would have a signal strength that exceeds what is expected. That is, the processor 118 evaluates the strength of the received laser signal, providing an initial assessment of the relative power compared to known baselines. The laser signal strength offers insight into the distance and quality of the laser beam 122 return.

In some examples, the laser signal is encoded with a signature using one or more modulation techniques, including time-based encoding (e.g., pulse sequences or pulse position modulation), frequency-based encoding, phase modulation, amplitude modulation, or combinations thereof. The encoded signature represents a predefined identifier associated with the transmitting system. In some examples, upon receiving a laser beam, the processor 118 decodes the laser signal to extract the signature and compares it to expected signatures. This process enables authentication of reflected laser signals and reduces false positives by distinguishing valid reflections from signals generated by external or adversarial sources.

In some examples, when the unrecognized laser beam is determined to be from a friendly source, no action is taken. In some examples, when the unrecognized laser beam is determined to be from a hostile source, a warning signal is transmitted by the system 100, warning other systems/vehicles of a possible danger. In addition to the warning signal or in place of the warning signal, the processor 118 may cause the vehicle 101 to execute an evasive maneuver, abort a mission, or execute a deployment of any payload on the vehicle 101.

In some examples, when the processor 118 identifies the received laser beam (e.g., the reflected laser beam 124) as the laser beam 122 transmitted from the laser transmitter 106 and reflected off of the object 120 based on laser data (e.g., a signal strength, directional data, and the encoded signature), the processor 118 computes a range of the object 120 and a vector to the object 120 using at least the signal strength, the directional data, and timing data. In some examples, the time data includes time-of-flight (ToF) data and ToF principles that are applied to compute the range of the object 120. In some examples, the laser beam 122 includes a pulsed or modulated laser signal (e.g., pulse, code, phase shift). That is, the laser signal may be implemented as a sequence of pulses (pulsed laser signal) or as a modulated waveform (e.g., amplitude or frequency-modulated) carried by a continuous laser beam. In some examples, the laser signal is a pulsed laser signal and the range is determined based on, for example, a pulse delay. In some examples, the laser signal is a modulated continuous-wave laser signal and the range is derived based on, for example, amplitude modulation, frequency modulation, and/or phase modulation. In some examples, utilizing combined inputs of the signal strength, the directional data, and the timing data, the processor 118 computes a distance (i.e., the range) and a directional path (i.e., the vector) to the object 120. The processor 118 interprets these variables to adjust the vehicle's trajectory in alignment with the object 120. In some examples, the signal strength is integrated with directional sensor data that is derived from other onboard sensors, such as the IMU 112, to assist in understanding the orientation and angle of approach between the vehicle 101 and the object 120. The computed range and vector information enable the processor 118 to make necessary adjustments to the vehicle's trajectory. By optimizing the path towards the designated object 120, the system ensures precise navigational corrections.

In some examples, instead of adjusting the current trajectory of the vehicle such that the adjusted current trajectory is aligned with the object 120, the processor 118 adjusts the current trajectory of the vehicle such that the adjusted current trajectory is not aligned with the object 120 or instead, executes a delivery of a payload on the vehicle. That is, based on the range to the object 120 and the vector to the object 120, the processor 118 may determine to abort the mission, and thus purposefully direct the vehicle 101 away from the object 120 and/or deliver the payload at that time. In some examples the decision to deliver the payload is not with respect to aborting the mission, but a determination that the vehicle 101 is close enough to the object 120 to deliver the payload. In some examples, delivering the payload comprises detonating the payload and/or the vehicle.

In some examples, the visual sensor 110 is also used along with the laser module 104 to provide improved guidance and navigation for the vehicle 101. In some examples, the visual sensor 110 is a downward-facing RGB camera that captures terrain imagery as the vehicle moves along the defined trajectory. In some examples, the visual sensor 110 captures sequential images of the terrain beneath the vehicle 101. These images are converted into digital data for processing where key feature points within the images are identified. In some examples, these points include edges, corners, or other distinguishable aspects of the terrain that remain consistent across consecutive images. In some examples, the processor 118 executes an optical flow estimation algorithm to track a displacement of the identified feature points between consecutive image frames. This displacement provides a measurement of a relative motion of the vehicle 101 with respect to the ground.

In some examples, the calculated optical flow results in motion vectors that describe the speed and direction of a movement of the vehicle 101. These vectors are utilized to determine translational and rotational movements. In some examples, the motion vectors are integrated with data from the IMU 112 to provide a comprehensive understanding of the movement of the vehicle. In some examples, this integration aids in recalibrating IMU readings and correcting roll and heading deviations, enhancing overall trajectory accuracy.

In some examples, to ensure that the vehicle 101 remains on its intended course, captured images from the visual sensor 110 are compared with satellite data. For example, the captured images are prepared for comparison with satellite data, and image mapping and registration techniques are employed to align the imagery with satellite-derived maps. Key features are extracted from both the captured images and the satellite data. These features may include landmarks, terrain patterns, or other distinguishable elements. The extracted features from the captured images are correlated with those from the satellite data, and the processor 118 analyzes these correlations to assess a degree of alignment, determining if a current path/trajectory of the vehicle 101 matches the defined trajectory.

In some examples, by comparing the captured images against the satellite data, any deviations from the predefined path are identified. In some examples, a deviation occurs when features in the captured images do not align with the corresponding features in the satellite data. In some examples, when deviations are detected, the processor 118 computes corrective adjustments to the current trajectory of the vehicle 101. Implementing these techniques ensures that the vehicle maintains its planned path, even in GPS-denied environments, by continually validating its course against satellite-derived maps. In some examples, rather than making these adjustments realign the vehicle 101 with its intended course, the adjustments purposefully deviate the vehicle 101 from the intended course as needed (e.g., to avoid the object 120). In some examples, there are no adjustments and instead, the processor 118 determines to execute a deployment of the payload.

In some examples, to reduce time and computing resources expended comparing captured images to satellite images, the processor 118 executes predictive algorithms to anticipate which satellite image area is most relevant for subsequent comparisons. In some examples, a known initial location of the vehicle 101 is established using a combination of last confirmed GPS coordinates (if available), inertial measurements, and visual data captured by onboard sensors. This initial positioning serves as a reference point for the prediction process. The processor 118 utilizes historical data, real-time sensor inputs, and mission-specific parameters to model probable vehicle trajectories while machine learning algorithms or predictive models take into account factors such as vehicle velocity, heading, and environmental constraints to forecast potential routes. In some examples, satellite data is organized into segmented map areas corresponding to different sections of the predicted trajectory. These areas are pre-processed and stored in an indexed format in an onboard system of the vehicle 101 for rapid retrieval during image comparison. The processor 118 evaluates a current direction of travel of the vehicle 101 using inertial and visual data, aligning this directional data with corresponding segmented satellite image areas. By correlating the directional heading with mapped trajectory predictions, subsequent satellite imagery likely positioned along a path of the vehicle 101 is prioritized. In some examples, as the vehicle 101 progresses, real-time data is utilized to adjust predictions continuously. Deviations from the anticipated path, detected via real-time sensor input integration, prompt the processor 118 to recalibrate and update satellite image area selections dynamically. In some examples, the processor 118 restricts satellite image comparison processes to segments that fall within the predicted trajectory zone. This targeted approach ensures that only the most relevant satellite image areas are evaluated, thereby reducing the overall computational load and comparison time.

By focusing comparisons only on satellite image segments that lie along the anticipated path, the system efficiently optimizes the image correlation process, thereby reducing time spent on unnecessary data matching and enhancing the overall responsiveness of the system 100.

In some examples, to enable precise synchronization of data between the visual sensor 110 and the IMU 112 for accurate range and navigation determinations, the processor 118 assesses a latency associated with a transmission of data from each sensor to the processor 118. For example, the visual sensor 110 incorporates a mechanism to timestamp each image capture event. These timestamps provide reference frames for determining a temporal context of acquired visual data. Alongside visual data, the visual sensor 110 transmits associated timestamps to the processor 118. This allows subsequent processes to associate imagery with precise capture times. The processor 118 processes an arrival time of each image data packet, comparing the arrival time to the original capture time. This comparison facilitates a computation of transmission delays from the visual sensor 110 to the processor 118.

In some examples, the IMU 112 similarly integrates time-stamping capabilities, associating each set of inertial readings with a precise temporal marker. Inertial data, combined with timestamp information, is relayed to the processor 118. Collecting this data during transmission allows the assessment of latency from the IMU 112 to the processor 118. In some examples, by comparing the IMU 112 data timestamps with reception times by the processor 118, the processor 118 calculates the latency associated with the inertial data transmission. In some examples, the processor 118 employs synchronization algorithms to align data from both sensors based on latency-corrected timestamps. This process ensures visual and inertial data are accurately correlated to the same temporal sequence. In some examples, the system continuously monitors and adjusts for any variances in latency, employing computational models that dynamically synchronize data inputs in real-time.

Through these latency measurement and synchronization techniques, the processor 118 ensures that it processes correct pairs of visual and inertial data. This precise alignment facilitates accurate computation of vehicle trajectories and navigation paths, enabling enhanced performance even in environments with unreliable GPS signals.

With respect to the VIO module 114, the system 100 integrates the VIO module 114 to refine dead reckoning accuracy. In some examples, this process involves a combination of visual data from the visual sensor 110 with readings from the IMU 112. By resetting certain metrics when specific visual cues are detected, the system 100 reduces cumulative errors in heading and roll estimation.

With respect to the radar module 116, which incorporates FMCW radar in some examples, the radar module 116 provides supplementary data related to the range and the vector. In some examples, the supplementary data is particularly valuable in situations where optical systems might be impacted by weather conditions or environmental scattering.

In some examples, outputs from the laser module 106, the visual sensor 110, the IMU 112, the VIO module 114, and the radar module 116 are weighted and combined using, for example, a sensor fusion algorithm, to produce a comprehensive and improved navigation output. In some examples, the fusion process includes dynamically assigning weights to the data from each sensor in the sensing components 102 based on current operational conditions and environmental factors, thus enhancing the overall system accuracy and reliability of the system 101. The laser module 104 provides precise ranging information and object designation capabilities through encoded laser signals. In some examples, because the output from the laser module 104 is useful for close-range targeting accuracy and authentication of signal sources, this data is assigned a higher weight in scenarios where line-of-sight to the object 120 is clear and laser signals are verified.

In some examples, the system 101 dynamically adjusts weighting of sensor inputs based on environmental conditions affecting sensor reliability. For instance, in environments with visual occlusion, such as fog, smoke, dust, precipitation, and/or low-light conditions, the processor 118 determines that optical data from the visual sensor 110 and/or the laser module 106 is degraded. In response, the system 101 increases a weighting assigned to radar data, such as data from the radar module 116, due to its robustness to such conditions. Thus, the radar module 116 serves as a primary source for range and vector determination while optical inputs are deprioritized.

In some examples, in clear line-of-sight conditions with high visibility and/or minimal environmental interference, the system 101 assigns greater weight to optical inputs, including laser return data and visual sensor data, to leverage higher-resolution targeting and feature detection capabilities. In these examples, radar data can serve as a complementary or confirmatory role.

In some examples, in mixed-condition environments, the processor 118 dynamically balances contributions from radar and optical sources, allowing one modality to compensate for partial degradation of another, thereby maintaining reliable navigation and targeting performance.

In some examples, the radar module 116, particularly when configured with FMCW technology, supplies supplementary range and vector information. Radar data is particularly valuable in environments where optical signals may be degraded due to adverse weather conditions or scattering effects. Thus, in some examples, radar outputs are weighted more heavily in these situations to compensate for the limitations in optical data, thereby enhancing the reliability of distance and directional estimates.

With respect to the visual sensor 110, the visual sensor 110 captures terrain imagery and performs optical flow analysis, providing valuable data on vehicle movement relative to the ground. In some examples, this visual data is integrated with inertial measurements for improved trajectory corrections and optically acquired data is prioritized when visual cues are prominent and environmental conditions favor clear imagery acquisition.

In some examples, the processor 118 computes a weighted output by integrating these diverse sensor inputs from the sensor components 102. The processor 118 evaluates a reliability and accuracy of data from each sensor under current conditions, and dynamically adjusts weights assigned to each sensor's data. By combining these weighted sensor outputs, the system 100 refines vehicle trajectory adjustments and optimizes navigation accuracy, facilitating precise path planning and object engagement. Through this adaptive process, the system 100 ensures that the most reliable data guides navigation decisions, maintaining robust performance across varied operational settings.

In the system 100, in some examples, a determination of weights for sensor data integration is dynamically adjusted based on the current operational conditions and environmental factors. The processor 118 executes algorithms to assess environmental conditions such as visibility, weather patterns, or electromagnetic interference. These factors can impact sensor reliability and the system's ability to detect and track objects (e.g., the object 120). For example, in adverse weather, radar data might be weighted more heavily due to its robustness under such conditions, whereas optical data might carry less weight because of possible visual obstructions.

In some examples, each sensor in the sensor components 102 is equipped to assess its own operational status and reliability, reporting metrics such as signal quality, data integrity, and any diagnostic error readings. The processor 118 evaluates these reliability metrics to determine a degree of confidence in each sensor's output, where a higher confidence corresponds to a greater weight in the fusion process.

In some examples, for sensors such as the radar module 116 and the laser module 104, a signal-to-noise ratio can provide insight into the clarity and reliability of received signals. Sensor data with a higher SNR might be designated a higher weight. Conversely, lower SNR might suggest a need for caution in relying on that sensor's output.

In some examples, historical data regarding each of the sensor components 102 performance in similar operational scenarios influences weight assignment where patterns indicating consistent accuracy or errors guide a recalibration of sensor importance.

In some examples, the system 100 implements machine learning algorithms that update weights based on past success rates and accuracy benchmarks.

In addition, a relevance of specific sensor data to a current navigational goal may influence weighting. For example, laser data may be emphasized during targeting phases, while visual data could be prioritized for navigation through complex terrains. In some examples, overall mission objectives and task requirements may dictate the strategic emphasis on particular data pathways.

The sensor fusion algorithm uses these collected insights to dynamically compute weights, ensuring that the system relies on the most relevant and reliable sensor data given the current context. This adaptive approach enhances navigation precision and system resilience in varied operational settings.

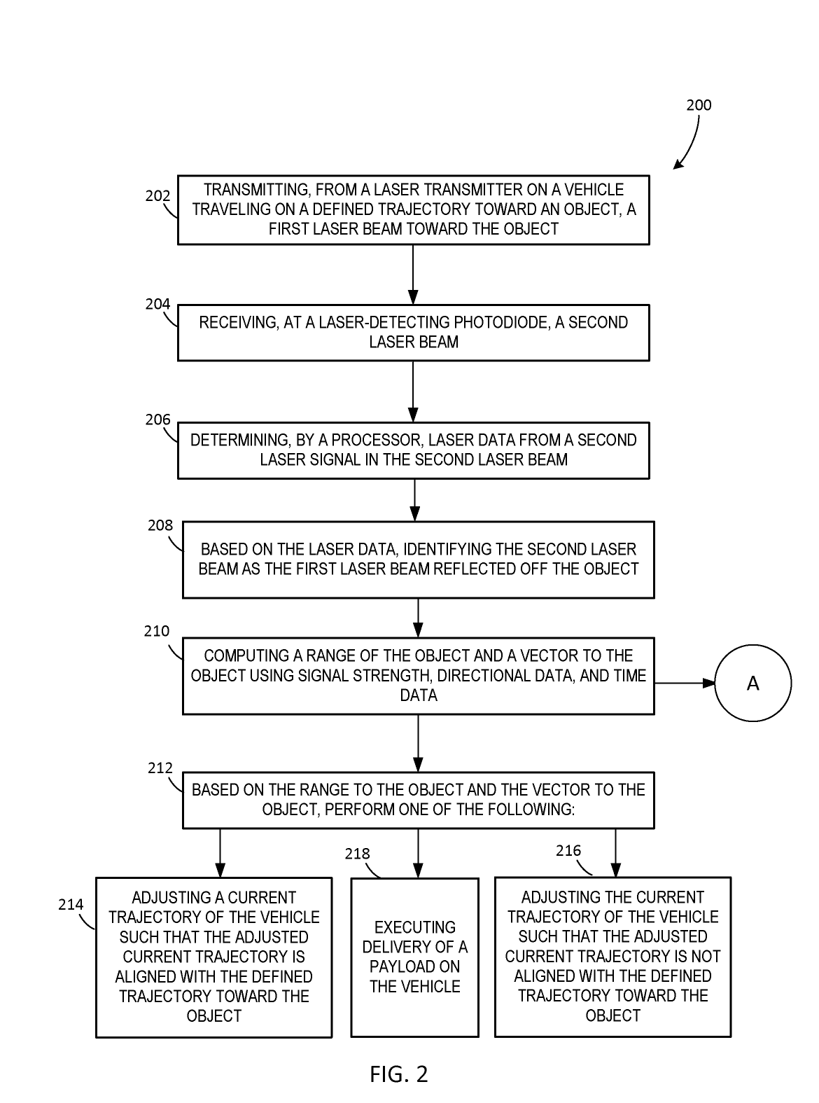

With reference now to FIG. 2, a flowchart illustrating an example method 200 of operations, functions, and/or the like of the system 100 (FIG. 1) is provided. At 202, a first laser beam (e.g., the laser beam 122) is transmitted (or the laser transmitter 106 is instructed to transmit the first laser beam 122), from the laser transmitter 106 on the vehicle 101 traveling on a defined trajectory toward an object (e.g., the object 120), toward a direction of the object 120. In some examples, the first laser beam includes a first laser signal having a first wavelength and a first signature encoded therein. At 204, a second laser beam (the reflected laser beam 124) having the first wavelength is received at the laser-detecting photodiode 108. In some examples, the laser-detecting photodiode 108 is configured to detect laser beams within a defined wavelength range. In some examples, the first wavelength is within the defined wavelength range of the laser-detecting photodiode 108, for example, between 906nm and 1550 nm, between 104 nm to 1550 nm, between 850 nm to 1310 or 1505 nm, between 1064 nm to 1mm, between 650nm to 850 or 905 nm, between 650 nm and 780 nm or 850 nm. Between 532nm and 785nm, or 850nm, or 1550nm.

At 206, laser data from a second laser signal in the second laser beam is determined by, for example, the processor 118. In some examples, the laser data includes a signal strength, directional data, timing data, and an encoded signature. In some examples, the processor 118 decodes the second laser signal, and based on the decoding, determines the second laser signal includes the first signature encoded therein. At 208, based on the laser data, the second laser beam is identified as the first laser beam reflected off of the object 120. At 210, based on identifying the second laser beam as the first laser beam reflected off of the object 120, a range of the object 120 and a vector to the object 120 is computed using the signal strength, the directional data, and the timing data. In some examples, the time data includes time-of-flight (ToF) data and ToF principles are applied to compute the range of the object 120. In some examples, the second laser beam includes a pulsed or modulated laser signal (e.g., pulse, code, phase shift). That is, the laser signal may be implemented as a sequence of pulses (pulsed laser signal) or as a modulated waveform (e.g., amplitude or frequency-modulated) carried by a continuous laser beam. In some examples, the laser signal is a pulsed laser signal and the range is determined based on, for example, a pulse delay. In some examples, the laser signal is a modulated continuous-wave laser signal and the range is derived based on, for example, amplitude modulation, frequency modulation, and/or phase modulation. At 212, based on the range to the object 120 and the vector to the object 120, one of the following is performed: at 214, adjusting a current trajectory of the vehicle 101 such that the adjusted current trajectory is aligned with the object 120; at 216, adjusting the current trajectory of the vehicle 101 such that the adjusted current trajectory is not aligned with the object 120; or at 218, executing a delivery of a payload on the vehicle 101.

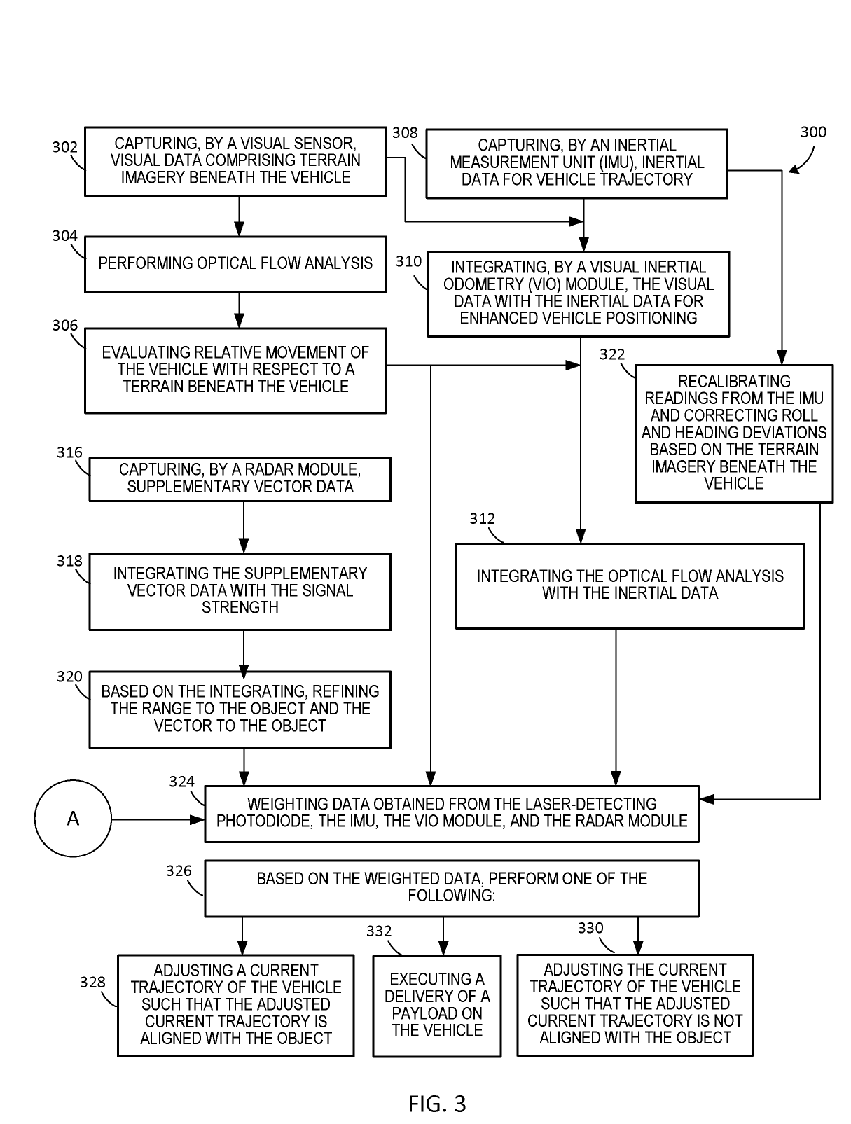

With reference now to FIG. 3, a flowchart illustrating an example of method 300 of operations, functions, and/or the like of the system 100 (FIG. 1) is provided. At 302, the visual sensor 110 captures visual data comprising terrain imagery beneath the vehicle 101. In some examples, the visual sensor 110 is a downward-facing camera.

At 304, the processor 118 performs optical flow analysis. At 306, the processor 118 evaluates relative movement of the vehicle 101 with respect to a terrain beneath the vehicle 101. At 308 inertial data is captured by the IMU 112 for vehicle trajectory. At 310, the visual data is integrated, by the VIO module 114, with the inertial data for enhanced vehicle positioning. At 312, the optical flow analysis is integrated with the inertial data to enhance an accuracy of the VIO module 114.

At 316, supplementary vector data is captured by the radar module 116 comprising a FMCW radar configuration. At 318, the supplementary vector data is integrated with the signal strength. At 320, based on the integrating, the range to the object 120 and the vector to the object 120 are refined. At 322, the terrain imagery beneath the vehicle 101 provides additional visual input for recalibrating readings from the IMU 112 and correcting roll and heading deviations.

At 324, data obtained from the laser-detecting photodiode 108, the IMU 112, the VIO module 114, and the radar module 116 are weighted. In some examples, the weighting of the data is performed prior to obtaining the data. In some examples, the weighting of the data is performed after obtaining the data. In some examples, a weight assigned to each type of the data is based on current operational conditions and environmental factors. In some examples, a weight assigned to each type of the data is based on environmental assessment, sensor reliability metrics, signal-to-noise ratio, historical performance data, and contextual relevance. At 326, one of the following is performed: at 328, adjusting the current trajectory of the vehicle 101 such that the adjusted current trajectory is aligned with the object 120; at 330, adjusting the current trajectory of the vehicle 101 such that the adjusted current trajectory is not aligned with the object 120; or at 332, executing the delivery of the payload.

### Exemplary Operating Environment

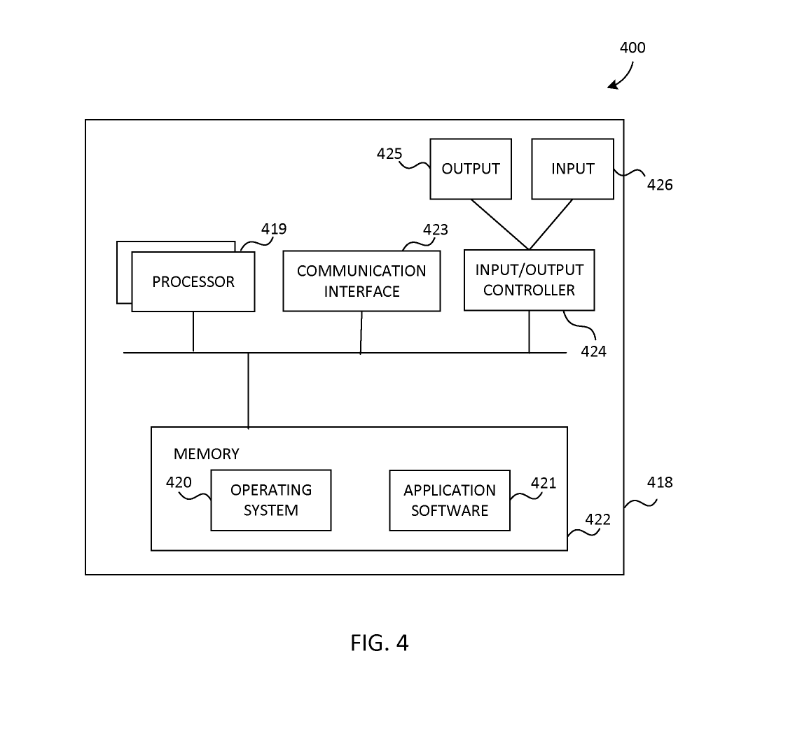

The present disclosure is operable with a computing apparatus according to an embodiment as a functional block diagram 400 in FIG. 4. In an example, components of a computing apparatus 418 are implemented as a part of an electronic device according to one or more embodiments described in this specification. The computing apparatus 418 comprises one or more processors 419 (e.g., one or more of the processor 118) which may be microprocessors, controllers, or any other suitable type of processors for processing computer executable instructions to control the operation of the electronic device. Alternatively, or in addition, the processor 419 is any technology capable of executing logic or instructions, such as a hard-coded machine. In some examples, platform software comprising an operating system 420 or any other suitable platform software is provided on the computing apparatus 418 to enable application software 421 to be executed on the device.

In some examples, computer executable instructions are provided using any computer-readable media that is accessible by the computing apparatus 418. Computer-readable media include, for example, computer storage media and communications media. Computer storage media, such as a memory 422 and the memory 130, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 422) is shown within the computing apparatus 418, it will be appreciated by a person skilled in the art, that, in some examples, the storage is distributed or located remotely and accessed via a network or other communication link (e.g., using a communication interface 423).

Further, in some examples, the computing apparatus 418 comprises an input/output controller 424 configured to output information to one or more output devices 425, for example a display (e.g., displaying a GUI) or a speaker, which are separate from or integral to the electronic device. Additionally, or alternatively, the input/output controller 424 is configured to receive and process an input from one or more input devices 426, for example, a keyboard, a microphone, or a touchpad. In one example, the output device 425 also acts as the input device. An example of such a device is a touch sensitive display. The input/output controller 424 may also output data to devices other than the output device, e.g., a locally connected printing device. In some examples, a user provides input to the input device(s) 426 and/or receives output from the output device(s) 425.

The functionality described herein can be performed, at least in part, by one or more hardware logic components. According to an embodiment, the computing apparatus 418 is configured by the program code when executed by the processor 419 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps) is within the scope of aspects of the disclosure.

The term “comprising” is used in this specification to mean including the feature(s) or act(s) followed thereafter, without excluding the presence of one or more additional features or acts. The terms "comprising," "including," and "having" are intended to be inclusive and mean that there can be additional elements other than the listed elements. In other words, the use of "including," "comprising," "having," "containing," "involving," and variations thereof, is meant to encompass the items listed thereafter and additional items. Accordingly, and for example, unless explicitly stated to the contrary, implementations "comprising" or "having" an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles "a," "an," "the," and "said" are intended to mean that there are one or more of the elements. In other words, the indefinite articles "a", “an”, “the”, and “said” as used in the specification and in the claims, unless clearly indicated to the contrary, should be understood to mean "at least one." Accordingly, and for example, as used herein, an element or step recited in the singular and preceded by the word "a" or "an" should be understood as not necessarily excluding the plural of the elements or steps.

The phrase “one or more of the following: A, B, and C” means “at least one of A and/or at least one of B and/or at least one of C." The phrase "and/or", as used in the specification and in the claims, should be understood to mean "either or both" of the elements so conjoined, i.e., elements that are conjunctively present in some cases and disjunctively present in other cases. Multiple elements listed with "and/or" should be construed in the same fashion, i.e., "one or more" of the elements so conjoined. Other elements may optionally be present other than the elements specifically identified by the "and/or" clause, whether related or unrelated to those elements specifically identified. Thus, as a non-limiting example, a reference to "A and/or B", when used in conjunction with open-ended language such as "comprising" can refer, in one implementation, to A only (optionally including elements other than B); in another implementation, to B only (optionally including elements other than A); in yet another implementation, to both A and B (optionally including other elements); etc.

As used in the specification and in the claims, "or" should be understood to have the same meaning as "and/or" as defined above. For example, when separating items in a list, "or" or "and/or" shall be interpreted as being inclusive, i.e., the inclusion of at least one, but also including more than one, of a number or list of elements, and, optionally, additional unlisted items. Only terms clearly indicated to the contrary, such as "only one of or "exactly one of," or, when used in the claims, "consisting of," will refer to the inclusion of exactly one element of a number or list of elements. In general, the term "or" as used shall only be interpreted as indicating exclusive alternatives (i.e., "one or the other but not both") when preceded by terms of exclusivity, such as "either," "one of' "only one of' or "exactly one of." "Consisting essentially of," when used in the claims, shall have its ordinary meaning as used in the field of patent law.

As used in the specification and in the claims, the phrase "at least one," in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase "at least one" refers, whether related or unrelated to those elements specifically identified. Thus, as a non-limiting example, "at least one of A and B" (or, equivalently, "at least one of A or B," or, equivalently "at least one of A and/or B") can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms "including" and "in which" are used as the plain-English equivalents of the respective terms "comprising" and "wherein." Moreover, the terms "first," "second," and "third," etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A computerized method comprising:
transmitting, from a laser transmitter on a vehicle traveling on a defined trajectory toward an object, a first laser beam toward a direction of the object, the first laser beam comprising a first laser signal having a first wavelength and a first signature encoded therein;
receiving, at a laser-detecting photodiode, a second laser beam having the first wavelength, wherein the laser-detecting photodiode is configured to detect laser beams within a defined wavelength range, and wherein the first wavelength is within the defined wavelength range;
determining, by a processor, laser data from a second laser signal in the second laser beam, the laser data comprising: a signal strength, directional data, timing data, and an encoded signature;
based on the laser data, identifying the second laser beam as the first laser beam reflected off of the object;
based on identifying the second laser beam as the first laser beam reflected off the object, computing a range of the object and a vector to the object using the signal strength, the directional data, and the timing data;
based on the range to the object and the vector to the object, perform one of the following:
adjusting a current trajectory of the vehicle such that the adjusted current trajectory is aligned with the object;
adjusting the current trajectory of the vehicle such that the adjusted current trajectory is not aligned with the object; or
executing a delivery of a payload on the vehicle.

2. The method according to claim 1, wherein determining the laser data comprises:
decoding, by the processor, the second laser signal; and
based on the decoding, determining, by the processor, the second laser signal comprises the first signature encoded therein.

3. The method according to claim 1, further comprising:
capturing, by a visual sensor, visual data comprising terrain imagery beneath the vehicle;
capturing, by an inertial measurement unit (IMU), inertial data for vehicle trajectory; and
integrating, by a visual inertial odometry (VIO) module, the visual data with the inertial data for enhanced vehicle positioning.

4. The method according to claim 3, wherein the visual sensor is a downward-facing camera; and wherein terrain imagery beneath the vehicle provide additional visual input for recalibrating readings from the IMU and correcting roll and heading deviations.

5. The method according to claim 4, further comprising:
performing, by the downward-facing camera, optical flow analysis;
evaluating, by the downward-facing camera, relative movement of the vehicle with respect to a terrain beneath the vehicle;
integrating the optical flow analysis and the relative movement of the vehicle with the inertial data to enhance an accuracy of the VIO module; and
based on the integrating, enhancing an accuracy of the VIO module.

6. The method according to claim 5, further comprising:
capturing, by a radar module comprising a Frequency Modulated Continuous Wave (FMCW) radar configuration, supplementary vector data;
integrating the supplementary vector data with the signal strength; and
based on the integrating, refining the range to the object and the vector to the object.

7. The method according to claim 6, further comprising:
weighting data obtained from the laser-detecting photodiode, the IMU, the VIO module, and the radar module; and
based on the weighted data, optimizing performing one of the following:
adjusting the current trajectory of the vehicle such that the adjusted current trajectory is aligned with the object;
adjusting the current trajectory of the vehicle such that the adjusted current trajectory is not aligned with the object; or
executing the delivery of the payload on the vehicle.

8. The method according to claim 7, wherein a weight assigned to each type of the data is based on current operational conditions and environmental factors.

9. The method according to claim 7, wherein a weight assigned to each type of the data is based on environmental assessment, sensor reliability metrics, signal-to-noise ratio, historical performance data, and contextual relevance.

10. A system comprising:
a vehicle comprising a laser transmitter and a laser-detecting photodiode;
a processor; and
a memory comprising computer-executable instructions that, when executed by the processor, cause the processor to perform the following operations while the vehicle is traveling on a defined trajectory toward an object:
instruct the laser transmitter to transmit a first laser beam toward a direction of the object, the first laser beam comprising a first laser signal having a first wavelength and a first signature encoded therein;
receiving, from the laser-detecting photodiode, information regarding a second laser beam received by the laser-detecting photodiode, the second laser beam having the first wavelength, wherein the laser-detecting photodiode is configured to detect laser beams within a defined wavelength range, and wherein the first wavelength is within the defined wavelength range;
determining, from the information, laser data from a second laser signal in the second laser beam, the laser data comprising: a signal strength, directional data, timing data, and an encoded signature;
based on the laser data, identifying the second laser beam as the first laser beam reflected off of the object;
based on identifying the second laser beam as the first laser beam reflected off of the object, computing a range of the object and a vector to the object using the signal strength, the directional data, and the timing data;
based on the range to the object and the vector to the object, perform one of the following:
adjusting a current trajectory of the vehicle such that the adjusted current trajectory is aligned with the object;
adjusting the current trajectory of the vehicle such that the adjusted current trajectory is not aligned with the object; or
executing a delivery of a payload on the vehicle.

11. The system according to claim 10, wherein determining the laser data comprises:
decoding the second laser signal; and
based on the decoding, determining the second laser signal comprises the first signature encoded therein.

12. The system according to claim 10 further comprising:
a visual sensor configured to capture visual data comprising terrain imagery beneath the vehicle;
an inertial measurement unit (IMU) configured to capture inertial data for vehicle trajectory; and
a visual inertial odometry (VIO) module configured to integrate the visual data with the inertial data for enhanced vehicle positioning.

13. The system according to claim 12, wherein the visual sensor is a downward-facing camera; and wherein terrain imagery beneath the vehicle provide additional visual input for recalibrating readings from the IMU and correcting roll and heading deviations.

14. The system according to claim 13, wherein the downward-facing camera is configured to:
perform optical flow analysis; and
evaluate relative movement of the vehicle with respect to a terrain beneath the vehicle.

15. The system according to claim 14, wherein the computer-executable instructions, when executed by the processor, further cause the processor to perform the following operations:
integrating the optical flow analysis and the relative movement of the vehicle with the inertial data to enhance an accuracy of the VIO module; and
based on the integrating, enhancing an accuracy of the VIO module.

16. The system according to claim 15, further comprising a radar module comprising a Frequency Modulated Continuous Wave (FMCW) radar configuration, the radar module configured to capture supplementary vector data; and
wherein the computer-executable instructions, when executed by the processor, further cause the processor to perform the following operations:
integrating the supplementary vector data with the signal strength; and
based on the integrating, refining the range to the object and the vector to the object.

17. The system according to claim 16, wherein the computer-executable instructions, when executed by the processor, further cause the processor to perform the following operations:
weighting data obtained from the laser-detecting photodiode, the IMU, the VIO module, and the radar module; and
based on the weighted data, optimizing performing one of the following:
adjusting the current trajectory of the vehicle such that the adjusted current trajectory is aligned with the object;
adjusting the current trajectory of the vehicle such that the adjusted current trajectory is not aligned with the object; or
executing the delivery of the payload on the vehicle.

18. The system according to claim 17, wherein a weight assigned to each type of the data is based on current operational conditions and environmental factors.

19. The system according to claim 17, wherein a weight assigned to each type of the data is based on environmental assessment, sensor reliability metrics, signal-to-noise ratio, historical performance data, and contextual relevance.

20. An apparatus comprising:
a processor; and
a memory comprising computer-executable instructions that, when executed by the processor, cause the processor to perform the following operations:
instruct a laser transmitter on a vehicle to transmit a first laser beam toward a direction of an object, the first laser beam comprising a first laser signal having a first wavelength and a first signature encoded therein;
receive, from a laser-detecting photodiode, information regarding a second laser beam received by the laser-detecting photodiode, the second laser beam having the first wavelength, wherein the laser-detecting photodiode is configured to detect laser beams within a defined wavelength range, and wherein the first wavelength is within the defined wavelength range;
determine, from the information, laser data from a second laser signal in the second laser beam, the laser data comprising: a signal strength, directional data, timing data, and an encoded signature;
based on the laser data, identify the second laser beam as the first laser beam reflected off of the object;
based on identifying the second laser beam as the first laser beam reflected off of the object, compute a range of the object and a vector to the object using the signal strength, the directional data, and the timing data;
based on the range to the object and the vector to the object, perform one of the following:
adjust a current trajectory of the vehicle such that the adjusted current trajectory is aligned with the object;
adjust the current trajectory of the vehicle such that the adjusted current trajectory is not aligned with the object; or
execute a delivery of a payload on the vehicle.
